(19) United States
(12) Patent Application Publication
(10) Pub. No.: US 2004/0101074 A1
(43) Pub. Date: May 27, 2004

(54) Filters and their use in digital communications

(76) Inventor: Alan Lee Wilson, Buffalo Grove, IL (US)

Correspondence Address: MOTOROLA, INC., 1303 EAST ALGONQUIN ROAD, IL01/3RD, SCHAUMBURG, IL, 60196

(21) Appl. No.: 10/303,277

(22) Filed: Nov. 25, 2002

(51) Int. Cl. H04B 1/10

(52) U.S. Cl. 375/350

(57) ABSTRACT

A filter device is for use in a digital communications receiver. The filter device processes an incoming signal from a digital transmitter having a first filter response providing a first spectral pulse shape in frequency space. The filter device has a second filter response having a more rapid cut-off than the first filter response and provides when applied to the first spectral pulse shape an output signal comprising a second spectral pulse shape in frequency space selected to substantially minimize inter-symbol interference. The second spectral shape may also be selected to substantially minimize adjacent-channel noise. A receiver and a communications system incorporating the filter device and a method of filtering in a receiver are also described.

### FIELD OF THE INVENTION

The present invention relates to filters and their use in digital communications, especially digital radio communications.

### BACKGROUND OF THE INVENTION

Digital communications systems generally provide communications between transmitters and receivers by a protocol having certain parameters defined in an industry standard. Digital radio transmitter and receiver circuits employ pulse shaping filters which enable information to be applied and extracted as modulations on a R.F. carrier signal. The kind of filter employed depends on the modulation system used. Generally, the modulation system is as defined in the industry standard for the particular communication system.

Modern filters implemented for digital radio communication systems such as systems operating according to TETRA, Project 25 or 3G standards, rely on a fairly precise filter implementation, particularly an implementation that is possible with a DSP (Digital Signal Processor). When the information is conveyed as a multi-level signal, of more than two possible states, then it conveys more than one bit in each multi-level signal. This signal is customarily called a “symbol”. It is useful to consider the transfer of information as units of “symbols” instead of bits, for a number of reasons as follows. The symbols can be adjusted to convey more bits, or fewer bits, according to the signal-to-noise ratio of the channel. In this situation, the symbol rate remains constant but the bit rate of the channel is dynamic. With 1 bit/symbol, the symbol has 2 levels. With 2 bits/symbol, the symbol has 4 levels (or perhaps 4 points in a 2 dimensional constellation). With 3 bits/symbols, the symbol has 8 levels or discrete points, etc. Another reason to symbols instead of bits is that the filtering for the channel is tailored to the symbol rate, not the bit rate. The filters are designed to satisfy the Nyquist Criterion for zero (or very low) inter-symbol interference. This means that a properly implemented receiver, with a properly designed filter line-up, will receive a signal that converges to discrete points or levels for each symbol. Any deviation from the discrete level will correspond to noise or interference on the channel, and not to any interference from nearby or adjacent symbols of the desired signal.

Harry Nyquist (1889-1976) was an engineer responsible for many principles and rules that are often used for communications systems. There is a Nyquist criterion for the stability of amplifiers with feedback loops. There is a Nyquist sampling rate limit for bandlimited signals. There is also a Nyquist criterion to minimize intersymbol interference in bandlimited signals. This last rule is of interest in the present situation since it affects the filter designs for digital communications systems. A filter which satisfies the Nyquist criterion for zero inter-symbol interference in a receiver is desirable for good receiver sensitivity.

Mobile radio communications systems operating according to the TETRA (Terrestrial Trunked Radio) standard mentioned earlier are finding wide use. These operational standards, which are for modern trunked RF communications systems, have been specified by the ETSI (European Telecommunications Standards Institute). In these standards, the communications protocol involves digital information (e.g. voice, data or picture/video information) being contained in phase components of a RF signal modulated using the DQPSK (differential quadrature phase shift keying) system generally. Signals sent to a BTS (base transceiver station) from a MS (mobile station)(the uplink) and from a BTS to a MS (downlink) are at different frequencies (FDD or frequency division duplex). Operating frequencies for TETRA systems are narrowband frequency channels which are in several specified frequency ranges including the following: (i) 380 MHz-390 MHz uplink/390 MHz-400 MHz downlink; (ii) 410 MHz-420 MHz uplink/420 MHz-430 MHz downlink. Each channel used has a bandwidth of 25 kHz and can carry 36 kbit/sec. The TETRA standard also defines protocols for direct communications (known in the art as ‘DMO’ or direct mode operation) between MSs. One MS operating with DMO can transmit directly to another MS without any intervening BTS to repeat the transmission.

The TETRA standard specifies that the transmitter will apply the required DQPSK modulation using a SRRC (square root raised cosine) filter having a roll-off factor α of 0.35. Such filters are well known in digital radio communications. The factor α is a measure in frequency space of the steepness of the sides of the narrow band pass frequency response curve, especially the steepness or rapidness of roll-off or cut-off on the higher frequency side, produced by the filter. The sides are steeper when the value of α is smaller. The total occupied bandwidth of an individual TETRA channel is 24.3 kHz. The TETRA standard also specifies the channel spacing (25 kHz) and the frequency stability is ±1 kHz for DMO operation.

For operation of a TETRA system in ‘DMO’, i.e. direct mode of operation between communicating units such as MSs, the frequency stability is specified as ±1 kHz in the TETRA standard. If two transmitters in adjacent channels each drift the maximum permissible amount toward each other, the frequency spectrums will overlap to a small amount. The normal implementation of the receiver in a system operating according to the TETRA standard is to use a SRRC matched filter operating at intermediate frequency (IF) and identical in response to the SRRC filter of the transmitter, i.e. a SRRC filter with α=0.35. In this case, the SRRC filter of the receiver will overlap the transmitted spectrum of an undesired interference signal from a transmitter in an adjacent channel, and adjacent channel rejection is greatly reduced. In other words, adjacent channel interference in TETRA DMO is likely if there is a maximum permitted drift in the transmitter frequencies of the two channels.

One purpose of the invention is to provide an improved filter for use in a receiver which reduces or avoids this problem. Other purposes and benefits of the invention will be apparent from the following description.

### SUMMARY OF THE PRESENT INVENTION

According to the present invention in a first aspect there is provided a filter device for use in a digital communications receiver to process an incoming signal from a digital transmitter having a first filter response providing a first spectral shape in frequency space, the filter device having a second filter response having a more rapid cut-off than the first filter response and providing when applied to the first spectral shape an output signal comprising a second spectral shape in frequency space selected to substantially minimize inter-symbol interference in the output signal, in accordance with the Nyquist criterion referred to earlier.

The second filter response may also be matched so as to filter channel noise associated with the incoming signal in order that the output power spectrum matches that of the desired signal.

Thus, the filter device according to the invention (when used as a receiver filter in a digital communications receiver) cuts off more rapidly in frequency space than the transmitter filter which has produced the incoming first spectral. The filter device achieves this by matching the less rapid filter cut-off of the transmitter filter response with a required faster filter cut-off which provides better receiver performance, i.e. minimum inter-symbol interference and minimum channel noise as mentioned earlier. This matching result may be obtained by generating in the filter device according to the invention a difference function (with the gain plotted in dBs) between the less rapid cut-off transmitter filter response and a faster cut-off filter response required to give the desired output second shape, and adding this difference function to the required faster cut-off response, to obtain and apply a composite response matched to the first spectral shape of the incoming signal.

The first and second spectral shapes may be represented as narrow pass band filters in frequency space.

The present invention allows the problem described earlier of overlapping spectra of adjacent channels in TETRA DMO to be solved. Further, the invention advantageously allows minimal noise in a receiver to be obtained, e.g. to minimise inter-symbol interference in a received digital signal, whilst surprisingly retaining numerous benefits obtained by using in a corresponding transmitter a filter having a frequency response which is different from that provided overall by the receiver filter, in particular a transmitter filter frequency response having a less steep cut-off. The numerous benefits obtained from the transmitter filter frequency response having a less steep cut-off include:

(i) a lower peak to average ratio for the transmitter RF power amplifier (RF PA);

(ii) the possibility of sharing RF PA technology between systems of different types, in particular including GSM systems which are already widely in use;

(iii) the possibility of providing backward compatibility with systems in which the transmitter spectral shape has already been standardised; so that battery drain, duty cycle, heat dissipation, power output are optimised; and

(iv) in systems that use a direct mode (DMO) as well as a trunked mode of communication between mobile stations, the possibility of using a common transmitter and receiver in both modes, even though the adjacent-channel interference properties are different in the two cases.

The first spectral shape (which represents the response function of the transmitter filter) may in one example comprise a SRRC (square root raised cosine) spectral function as known in the art and used for example in various mobile communications systems, e.g. systems operating according to the TETRA standard. Such a spectral shape in the prior art is usually matched by a filter having an identical SRRC response in the receiver to provide an output which is a simple raised cosine function. However, by use of the invention, the filter of the transmitter may have a response in which the cut-off of the SRRC shape of the transmitter filter is less rapid (i.e. the response function has a larger roll-off factor (α)) than that required in a matched filter pair to give the required raised cosine output function, thereby allowing the benefits associated with a more rapid receiver cut-off and less rapid transmitter cut-off described above to be obtained. In this example, the filter device according to the invention effectively distorts the SRRC spectral shape of the incoming signal to provide an output of raised cosine form which appears to have resulted from a transmitter SRRC filter having a more rapid SRRC cut-off than that actually used.

Alternatively, the first spectral shape (which represents the response function of the transmitter filter) may in a second example comprise another spectral shape such as a trapezoidal shape (wherein the closing side of the trapezium is the frequency axis). The trapezoidal shape produced by the transmitter filter has a less steep cut-off than that required in the output response of the receiver filter. The output response may itself comprise or approximate to a trapezoidal function having a steeper cut-off than that of the transmitter filter. The output response may be obtained (in a manner similar to that described above for a raised cosine response) by applying a suitable modified filter function to the spectral shape of the incoming signal.

Examples of applying the invention based on processing of incoming signals produced by transmitter filters having other forms of frequency response are possible as will be readily apparent to those skilled in the art

The filter response function to be applied in the filter device according to the present invention is easily constructed. As described earlier, the function includes the difference, as a function of frequency, in the gain (in dB) required between the incoming first spectral shape as produced by the system transmitter and the output signal function or second spectral shape. This difference function is constructed as a function of gain in dB versus frequency, or as a ratio if the response is to be calculated on a linear scale. This required difference (or ratio) function is easily determined graphically, in a table or spreadsheet, or by a mathematical formula by those skilled in the art of filter design. The difference (or ratio) function is then added to the narrow band receiver response required from the filter device to minimize inter-symbol interference and adjacent-channel noise. The result provides the novel combined filter response function.

The implementation of the novel combined filter response function (referred to earlier as the second response) in the filter device according to the invention can be done in hardware and/or software form using design and operating procedures which are known per se in the art. Most modern filter implementations used in digital communications systems employ a programmable DSP (digital signal processor) to process the digital signals to provide various functions including the required filter functions. The second response function of the filter device according to the invention may be provided by such a DSP. The DSP implements a filter by use of a series of filter coefficients in a filter configuration determined by the preference of the designer. A frequently used implementation form which may be used in the filter device of the present invention employs a FIR (Finite Impulse Response) filter, in which case the filter coefficients are calculated to obtain an impulse response in the time domain which is the inverse Fourier transform of the desired frequency response. The DSP is programmed to store the filter coefficients as a vector of numbers depending on the sample rates and desired precision for the frequency response. For example, a length of 50 coefficients is required for a filter spanning a time interval of 5 symbol times with 10 samples per symbol. The software then executes the filter by a series of multiplications and additions, often done by a “multiply and add” instruction routine in the DSP.

In hardware implementations, the principle is the same but the required microprocessor technology is different. A hardware design with a DSP will employ a semiconductor, e.g. silicon, integrated circuit with a DSP building block, together with a memory, e.g. a ROM (read only memory) to include the execution code for the DSP. Included in the memory are the filter coefficients. The DSP operates much as in the software design. For example, filter implementations using a microprocessor, e.g. the product supplied by Motorola under the trade name Abacus™ or supplied by Analog Devices under the trade designation AD 9874, are examples of hardware implementations.

The implementation of the filter device according to the invention may be at baseband or at an intermediate frequency (IF) depending on the architecture used. Some microprocessors such as Abacus™ mentioned above operate at a non-zero frequency and therefore use of such devices in implementation of the invention is at an IF.

According to the present invention in a second aspect there is provided a digital communications receiver which includes a filter device according to the first aspect.

According to the present invention in a third aspect there is provided a digital communications system including a transmitter and a receiver in which the transmitter and receiver include symbol filters, wherein the transmitter symbol filter has a first response such as to produce a first spectral shape in frequency space and wherein the receiver symbol filter has a second response having a more rapid cut-off in frequency space and providing, when applied to the first spectral shape, an output signal comprising a second spectral shape in frequency space selected to substantially minimize inter-symbol interference. According to the present invention in a fourth aspect there is provided a method in a digital communications receiver of filtering an incoming signal from a digital transmitter having a first filter response providing a first spectral shape in frequency space, the filter device having a second filter response having a more rapid cut-off than the first filter response and providing when applied to the first spectral shape an output signal comprising a second spectral shape in frequency space selected to minimize inter-symbol interference.

The transmitter and receiver in any of the above aspects of the invention may respectively be used in any suitable component unit of a radio communications system. For example, these functions may be used in a fixed transmitter or receiver unit as appropriate, e.g. in a base transceiver station, or in a mobile or portable radio unit, e.g. in the transceiver of such a station or radio unit.

Embodiments of the present invention will now be described by way of example with reference to the accompanying drawings, in which:

### BRIEF DESCRIPTION OF THE ACCOMPANYING DRAWINGS

FIG. 1 is a block schematic diagram illustrating functional blocks of a transmitter and receiver in a digital communications system.

FIG. 2 is a graphical diagram showing the gain v frequency response of symbol filters used in a prior art transmitter/filter arrangement.

FIG. 3 is a graphical diagram showing the gain v frequency response of symbol filters used in a transmitter/receiver arrangement embodying the invention.

FIG. 4 is a more detailed plot of the novel response curve shown in FIG. 3(b) together with corresponding plots of known filter responses.

FIG. 5 is a waveform diagram showing the gain v frequency response of symbol filters used in an alternative transmitter/receiver arrangement embodying the invention.

### DETAILED DESCRIPTION OF EMBODIMENTS OF THE INVENTION

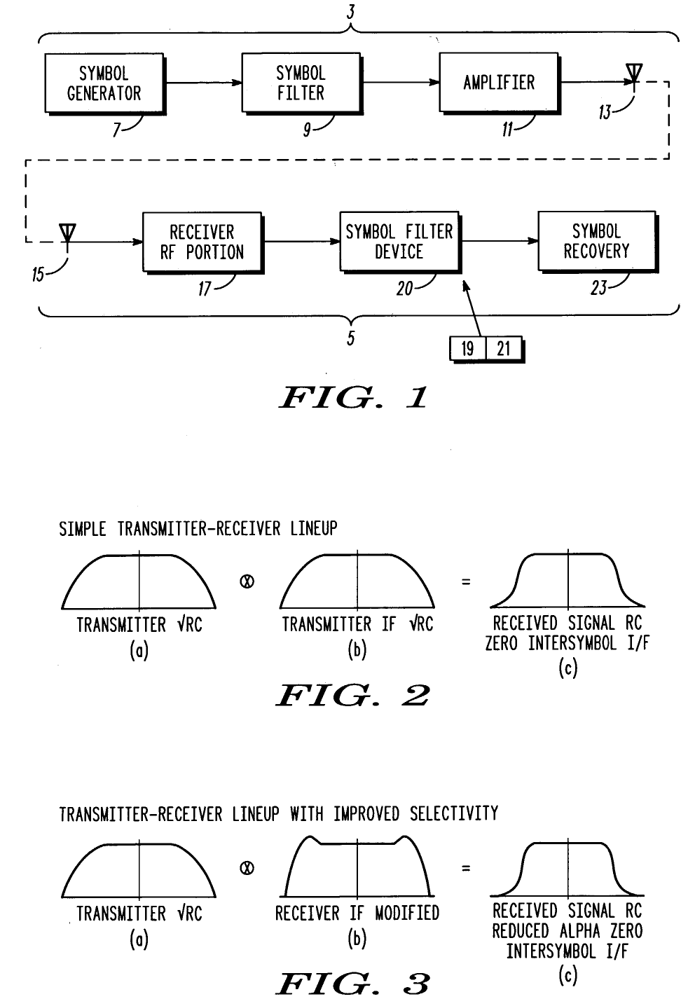

As shown in FIG. 1, a digital communications system 1 includes a radio transmitter 3 and a radio receiver 5. The transmitter 3 includes a symbol generator 7, providing a signal comprising information-representing symbols which is filtered at an intermediate frequency (IF) by a symbol filter 9. The signal, which is provided as an output from the filter 9, is amplified by a RF power amplifier 11 and is sent as a radiated RF electromagnetic signal by an antenna 13 to one or more distant receivers. An antenna 15 of a distant receiver 5 picks up the signal from the antenna 13 of the transmitter 3. The signal is processed by a RF portion 17 of the receiver 5. An output of the RF portion 17 is filtered at IF by a filter device 20. The filter device 20 has a frequency response which corresponds to an example of the second response referred to earlier. For ease of understanding, the filter device 20 is shown as comprising a first symbol filter function 19 followed by a second symbol filter function 21. In practice, the first symbol filter function 19 and the second filter function 21 may be combined as explained earlier. A filtered output of the filter device 20 comprising the first filter function 19 and the second filter function 21 is delivered to a symbol recovery function 23 from which a received information output is provided. Depending on the type of information provided as an input and represented by the symbols in the symbol generator 7 of the transmitter 3, e.g. speech, text data, picture or video information, etc, the output of the symbol recovery function 23 may be converted in a known manner into the same kind of information for output to a user.

The filter device 20 comprising the first filter function 19 and the second filter function 21 replaces a known receiver symbol filter as used in the prior art. FIG. 2 illustrates such a prior art operation. An example of the spectral pulse shape in the frequency domain resulting as the output from the symbol filter of the transmitter 3 is shown in FIG. 2(a). This is a familiar SRRC shape used for example in transmitters operating according to TETRA standards.

The SRRC shape has in frequency space leading and trailing edges defined by the roll-off factor α. The edges become steeper as the value of α decreases and overall the unit width of the spectral pulse in frequency space decreases. In the prior art, the single symbol filter employed in the receiver has a filter response which matches this shape as shown in FIG. 2(b), i.e. the transmitter and receiver symbol filters acting together in cascade provide a matched pair providing a raised cosine function output as shown in FIG. 2(c).

The arrangement shown in FIG. 1 also produces a raised cosine output. However, in accordance with an embodiment of the invention, the filter device 20 of the receiver 5 operates in a manner different from the prior art. The filter device 20 of the FIG. 1 arrangement provides a distorted filter function having a shape as shown in FIG. 3(b). As shown in FIG. 1, filter device 20 can be functionally decomposed into function 19 and function 21. The function 19 distorts the spectral pulse shape of the incoming signal to the receiver 5 so that it appears to have been sent from a transmitter in which the symbol filter is a SRRC filter having a smaller a value, namely α=0.2. The function 21 then corresponds to a SRRC filter with α=0.2 to complete the filtering the receiver and satisfy the Nyquist criterion for minimum intersymbol interference. The cascaded combination of the first filter function 19 with the second filter function 21 is illustrated in FIG. 3(b) as the overall response of filter device 20 in the receiver 5. This can then be cascaded with the symbol filter 9 of transmitter 3, whose response is shown in FIG. 3(a), to thereby provide an output (the second spectral shape referred to earlier) which is a raised cosine function with α=0.2 as illustrated in FIG. 3(c).

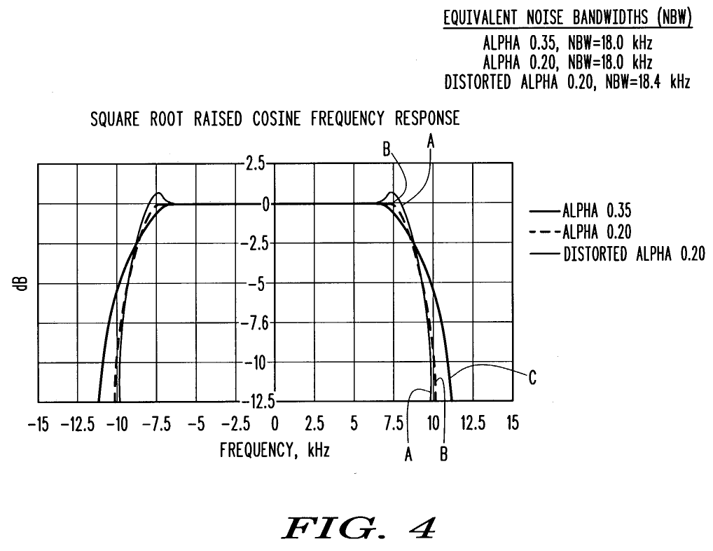

FIG. 4 shows in more detail a graphical plot of the response in dB of the filter device 20 to distort α=0.35 down to α=0.2. The plot is labelled as curve A in FIG. 4. Also shown in FIG. 4 for comparison purposes are the curves obtained using SRRC filters providing α=0.2 and α=0.35 respectively. These curves are labelled B and C in FIG. 4 respectively. The decomposition of the response of filter device 20 into filter function 19 and 21 is then easily determined in FIG. 4. Filter function 19 is the difference between curves B and C (which respectively represent α=0.2 and α=0.35), and filter function 21 is simply curve B. The sum will result in curve A.

If the equivalent noise bandwidth is also computed for the first filter function 19 represented by curve A in FIG. 4, it is slightly higher than the matched filter noise bandwidth. This slight increase will reduce the receiver sensitivity by about 0.1 dB, but this reduction is not enough to cause any problem in typical digital radio receiver designs.

The filter device 20 comprising the symbol first filter function 19 and the symbol second filter function 21 of the receiver 5 when applied in a TETRA system is capable of fully rejecting adjacent channel transmitter signals, even if both the receiver and transmitter drift by as much as 1 kHz each. It is also fully compatible and interoperable with all TETRA standard transmitters.

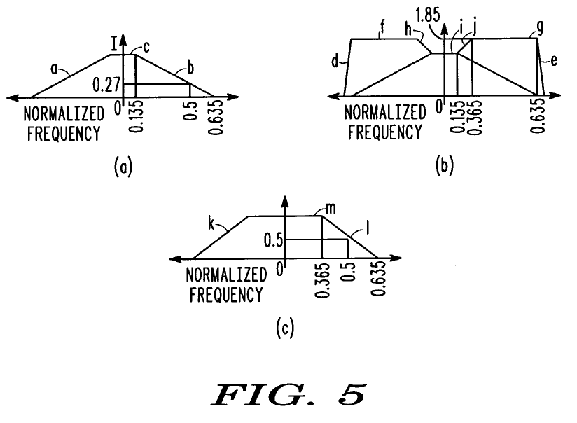

FIG. 5 illustrates the symbol filter responses used in an alternative form of the arrangement shown in FIG. 1. The full lines of the responses shown in FIG. 5 represent the filter response function in each case and the dashed lines are illustrative lines to indicate various dimension points on the response functions. In the case of the embodiment illustrated in FIG. 5, the response, i.e. gain (in dB) versus normalized frequency, of the filter 9 of the transmitter 3 is the trapezoidal shape illustrated in FIG. 5(a) which is symmetrical about an origin O which represents a centre frequency or half sampling rate. This shape consists of sloping sides a and b and a top c parallel with the normalized frequency axis. In this shape, which is symmetrical about the origin O (which represents the centre frequency), the height is 1 amplitude (gain) unit at the top c and the width of the top c is (0.135×2)=0.270 normalized frequency (sampling rate) units. The vertical height of the sloping sides a and b is 0.27 amplitude (gain) units at a normalized frequency of 0.5 units from the origin O. The vertical height falls to zero at a normalized frequency which is 0.635 units from the origin O.

In the case of the embodiment illustrated in FIG. 5, the gain versus normalized frequency response of the filter device 20 is the distorted trapezoidal shape illustrated in FIG. 5(b). This shape consists of sides d, e, f, g, h, i and j. In this shape, which is again symmetrical about the origin, the maximum height at sides f and g forming a top portion parallel with the axis is 1.85 gain units. The height falls to 1 amplitude {gain) unit in a sunken top region consisting of the three sides h, i and j. The width of the side i at the bottom of this sunken region is the same as that of the top c in FIG. 5(a), namely (2×0.135) 0.27 amplitude units. The overall width of the sunken region at the top (maximum height) is (0.365×2) 0.73 normalized frequency units. The sides f and g at the top of the response extend to a normalized frequency of 0.635 units on each side of the origin. The response shown in FIG. 5(b) has sloping leading and trailing edges formed by the sides d and e which fall from the top at this height. The filter cuts off rapidly beyond the normalized frequency of 0.635 units so as to limit undesired noise outside the pass band. The actual cut off point depends on the number of filter coefficients implemented in the filter and the desired pass band ripples, according to well known filter design principles (see for example Lawrence Rabiner and Bernard Gold, Theory and Application of Digital Signal Processing, Chapter 3, Prentice Hall, 1975).

In the case of the embodiment illustrated in FIG. 5, the output spectral shape is the trapezoidal shape illustrated in FIG. 5(c). This is the result of the cascaded effect of the response functions shown in FIG. 5(a) and (b). The spectral shape shown in FIG. 5(c) has sides k and l and a top m and is again symmetrical about the origin O. The shape shown in FIG. 5(c) is of trapezium form similar to that shown in FIG. 5(a) but in the FIG. 5(c) case the top m is longer than the top c in FIG. 5(a) and the sides k and l are steeper than the sides a and b in FIG. 5(a). The width of the top m is (2×0.365=) 0.73 normalized frequency units and the sides k and 1 fall to half height at a normalized frequency 0.5 units from the origin O.

FIG. 5 shows how a filter providing a trapezoidal response may be used in the transmitter and a filter having novel composite response may be used in the receiver to give a desired trapezoidal output, wherein the response of the receiver filter beneficially has steeper sides (especially steeper cut-off) than that of the transmitter filter response. Filters having the responses illustrated in FIG. 5 may beneficially be used in a F4FM (Filtered 4-level Frequency Modulation) communication system in which the transmitter filter response is specified to be as shown in FIG. 5(a) but the receiver filter response is unspecified.

Use of the arrangement shown in FIG. 1 wherein the response of the filter device 20 is as shown in FIG. 5(b) beneficially gives the output shown in FIG. 5(c), i.e. a trapezoidal response that has an amplitude of 0.5 at a frequency of 0.5 times the symbol rate and is band limited at 0.635 times the symbol rate, which satisfies the Nyquist criterion for inter-symbol interference when used in conjunction with the transmitter symbol filter 9. In an alternative embodiment of the invention (not shown) another output spectral shape (second spectral shape) which is similarly band limited at or less than 0.635 times the symbol rate so as also to meet the Nyquist Criterion may be produced. Another example of the second spectral shape produced in this way is a raised cosine response with α=0.27.

Thus, the arrangement shown in FIG. 1 allows use of transmitter filters having the response shown in FIG. 5(a), which are similar to filters already specified for use in other systems, namely the standardised system known as C4FM (Compatible 4-level Frequency Modulation) as used in the ANSI/TIA/EIA-102.BAAA standard for APCO Project 25, to be used in new systems having receivers with various different output spectral forms.

1. A filter device for use in a digital communications receiver to process an incoming signal from a digital transmitter having a first filter response providing a first spectral shape in frequency space, the filter device having a second filter response having a more rapid cut-off than the first filter response and providing when applied to the first spectral shape an output signal comprising a second spectral shape in frequency space selected to substantially minimize inter-symbol interference.

2. The filter device according to claim 1, wherein the first and second spectral shapes are narrow pass band filters in frequency space.

3. The filter device according to claim 1, and wherein the second filter response is selected such that adjacent-channel noise in the receiver is substantially minimized.

4. The filter device according to claim 1, wherein the second filter response comprises a composite response which is equivalent to the sum of (i) a response having a third spectral shape having a more rapid cut-off in frequency space than the first spectral shape and which when used in a matched filter pair would give the second spectral shape as a required output; and (ii) the difference, with gain plotted in decibels versus frequency, between the first spectral shape and the third spectral shape.

5. The filter device according to claim 5, which is operable such that the first and third spectral shapes comprise different square root raised cosine spectral functions, the third spectral shape having a more rapid cut-off in frequency space than the first spectral shape, and wherein the second spectral shape comprises a raised cosine spectral function.

6. The filter device according to claim 4, which is operable such that the first and second spectral shapes comprise trapezoidal shapes, the trapezoidal shape of the second shape having a more rapid cut-off in frequency space than that of the first shape.

7. The filter device according to claim 6, which is operable such that the first and second spectral shapes have a flat top portion, wherein the flat top portion of the second spectral shape is longer in frequency space than that of the first spectral shape.

8. The filter device according to claim 1, wherein the device comprises at least one digital signal processor to process digital signals to provide the required second filter response.

9. The filter device according to claim 8, which comprises a Finite Impulse Response filter operable to apply filter coefficients which represent an inverse Fourier transform of the desired frequency response.

10. The filter device according to claim 8, wherein the filter device is operable to obtain the second filter response by applying in the digital signal processor one or more mathematical operations comprising a series of multiplications and additions.

11. The filter device according to claim 8, which further comprises a memory, in which are stored filter coefficients for application by the digital signal processor to operate a function to provide the second filter response.

12. A digital communications receiver which incorporates a filter device, the filter device comprising a processor operable to process an incoming signal from a digital transmitter having a first filter response providing a first spectral shape in frequency space, the filter device having a second filter response having a more rapid cut-off in frequency space than the first filter response and providing when applied to the first spectral shape an output signal comprising a second spectral shape in frequency space selected to substantially minimize inter-symbol interference.

13. A digital communications system comprising a transmitter and a receiver in which the transmitter and receiver include symbol filters, wherein the transmitter symbol filter has a first filter response such as to produce a first spectral shape in frequency space and wherein the receiver symbol filter has a second filter response having a more rapid cut-off in frequency space than the first filter response and providing when applied to the first spectral shape an output signal comprising a second spectral shape in frequency space selected to substantially minimize inter-symbol interference.

14. A method in a digital communications receiver of filtering an incoming signal from a digital transmitter having a first filter response providing a first spectral shape in frequency space, the filter device having a second filter response having a more rapid cut-off than the first filter response and providing when applied to the first spectral shape an output signal comprising a second spectral pulse shape in frequency space selected to minimize inter-symbol interference.

15. The method according to claim 14, wherein the second filter response is selected such that adjacent-channel noise in the receiver is substantially minimized.

16. The method according to claim 15, wherein the second filter response comprises a composite response which is equivalent to the sum of (i) a third spectral shape having a more rapid cut-off in frequency space than the first spectral shape and which when used in a matched filter pair would give the second spectral shape as a required output and (ii) the difference, with amplitude plotted in decibels against frequency, between the first spectral shape and the third spectral shape.

17. The method according to claim 16, wherein the first and third spectral shapes comprise different square root raised cosine spectral functions, the third spectral shape having a more rapid cut-off in frequency space than the first spectral shape, and wherein the second spectral shape comprises a raised cosine spectral function.

18. The method according to claim 16, wherein the first and second spectral shapes comprise different trapezoidal shapes, the trapezoidal shape of the second shape having a more rapid cut-off in frequency space than that of the first spectral shape.

19. The method according to claim 18, which is operable such that the first and second spectral shapes have a flat top portion, wherein the flat top portion of the second spectral shape is longer in frequency space than that of the first spectral pulse shape.

20. The method according to claim 14, wherein the filter device comprises at least one digital signal processor operable to process digital signals to provide the second filter response.

21. The method according to claim 19, wherein the filter device comprises a Finite Impulse Response filter operable to apply filter coefficients which represent an inverse Fourier transform of the desired frequency response.

22. The method according to claim 20, wherein the filter device is operable to obtain the second filter response by applying in the digital signal processor one or more mathematical operations comprising a series of multiplications and additions.

23. The method according to claim 20, which comprises storing filter coefficients in a memory and applying the stored coefficients to the digital signal processor for application by the digital signal processor to operate a function to provide the second filter response.

24. The method according to claim 23, wherein the second filter response provided by the digital signal processor comprises a composite response which is equivalent to the sum of (i) a third spectral shape having a more rapid cut off than the first spectral pulse shape and which when used in a matched filter pair would give the second spectral shape as a required output and (ii) the difference, with amplitude plotted in decibels, between the first spectral shape and the third spectral shape.

25. The method according to claim 14, wherein the incoming signal comprises a modulated information-carrying radio frequency signal and the receiver applies the filtering to demodulate the incoming signal.
